(19) United States
(12) Patent Application Publication
(10) Pub. No.: US 2009/0303175 A1
(43) Pub. Date: Dec. 10, 2009

(54) Haptic user interface

(75) Inventor: Rami Arto Koivunen, Turku (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/157,169

(22) Filed: Jun. 5, 2008

(51) Int. Cl. G09G 5/00

(52) U.S. Cl. 345/156

(57) ABSTRACT

This invention relates to a method, apparatuses and a computer-readable medium having a computer program stored thereon, the method, apparatuses and computer program using a haptic signal perceptible by a user contacting a user interface surface with an input means (device) to indicate a predetermined direction on the user interface surface.

### TECHNICAL FIELD

This invention relates to the generation of haptic signals for indicating the direction of a user interface surface position to a user.

### BACKGROUND OF THE INVENTION

User interfaces are used in a variety of applications. They serve for providing user instructions to, among many others, computers, mobile phones, television set-top boxes or personal digital assistants. In industrial applications, for instance, user interfaces are used for controlling a manufacturing process.

Many user interface technologies rely on input means contacting the user interface surface. Within this category fall keyboards having buttons to be pressed by a user in order to make, for instance, a computer processor perform a certain action. In this case, the signal generated is an electrical signal. Usually, different buttons are associated with different actions being performed by the processor.

Other user interfaces are, for example, touch pads or touch screens. These devices have certain areas to be touched by the user either directly or indirectly which generate different signals. While some of these devices may require the user to actually push an area for signal generation it may suffice in other devices to place a finger within the area and a signal is generated. Other areas may be inactive, i.e. they may not be associated with signal generation. Thus, they do not form functional areas.

User interface design is an important factor to account for when aiming at enhanced user experience as user interfaces are the part of a user controlled system the user interacts with.

In many applications it is desirable that the user does not need to have visual contact to the user interface in order to be able to operate it because, for instance, he has to attend to information shown on a display. In such a situation user experience can be improved by giving non-visual feedback to the user providing information on how to handle the user interface.

For example, when a user places his fingers on a computer keyboard, it is likely that he wants to type a text. The proper starting position for touch typing is the center row of alphabetical keys, sometimes called home row. A common approach to indicate the basic position within this row is to mark certain buttons, for instance those linked to the letters F and J, with a bump. The bumps provide haptic information to the user. However, the user does not know where the correct position for his fingers is to be found until he has actually reached it.

When operating a touch pad, the user may, for example, press an inactive area instead of an active area. This can be indicated to the user by generating an acoustic warning signal. Of course, this does also not provide information to on the position of the closest active area.

### SUMMARY OF THE INVENTION

A method is described which comprises generating a haptic signal perceptible by a user contacting a user interface surface with input means. The haptic signal is suitable for indicating a predetermined direction on the user interface surface.

Further, an apparatus is described which comprises a controller configured to provide a control signal. The control signal is suitable for controlling a haptic sensation generation element to generate a haptic signal. The haptic signal is perceptible by a user contacting a user interface surface with input means and the haptic signal is suitable for indicating a predetermined direction on the user interface surface.

Moreover, a computer-readable medium is described on which a computer program is stored. When executed by a processor, the program code realizes the described method. The computer readable medium could for example be a separate memory device or a memory that is to be integrated in an electronic device.

The invention is further directed to an apparatus comprising means for providing a control signal, wherein the control signal is suitable for controlling a haptic sensation generation element to generate a haptic signal perceptible by a user contacting a user interface surface with input means and the haptic signal is suitable for indicating a predetermined direction on the user interface surface.

A user interface allows the user to affect parameters of a system connected thereto. Among many others, a mechanical button to be pressed by a user is a user interface. Computer keyboards are user interfaces generating electric signals for a computer to process. Other interface technologies are touch pads and touch screens. Operator panels of, for instance, control terminals are encompassed by the term, too. Although many user interfaces are provided with a substantially planar surface, this is not a precondition for a user interface to be used in the context of the present invention. For example, a touch screen can be formed on the surface of a ball or any other body having any imaginable shape.

The mode of operation of these interfaces sometimes involves locating the position of input means contacting a surface element or area of the user interface. A computer keyboard generates a signal based on the button being pressed, i.e. the position of a user's finger. A touch pad may behave accordingly if it uses a sensor for detecting pressure exerted by the user.

For this purpose, resistive sensors are a possible sensor technology. When pressed, two electrically conductive elements connect and a current is able to flow, thereby forming an electrical signal. Conductive sensors do not rely on pressure exerted on them but on the capacitive coupling of input means positioned on or near them and a capacitor within the sensor element. Infrared sensors are in many cases arranged in a grid across the surface of the user interface. The location of the input means can then be detected based on the interruption of infrared light beams by the input means.

In some cases, it can suffice not to detect a position of contact of the input means and the user interface surface. Instead, a signal may be generated if the user interface is contacted at an arbitrary position, i.e. it is not important where the interface is contacted, but that it is contacted at all.

Input means comprises any means suitable for contacting the user interface. This includes body parts of a user. For example the user can operate a touch screen not only with his fingers but with a palm instead. In case of, for instance, a video game console user interface, the user may even operate it with his feet as input means. For operation of a touch screen a stylus is a common input means.

The user interface may be connected to or form part of various types of systems. For example, it can be connected to a personal computer by a universal serial bus connector. Wireless communication of the user interface and the entity to be controlled by it is another possible solution. Touch pads can form part of a notebook. A variety of portable electronic devices such as, among many others, personal digital assistants, mobile phones or handheld game consoles can comprise a touch screen.

An advantage of the present invention is that the user is able to perceive information indicating a direction on the surface of the user interface. This enables the user to move the input means, for example a finger, in the indicated direction, if desired.

A field of application for such an embodiment of the present invention is user controlled computer software. In many computer programs user instructions are necessary at a certain stage of execution. The program may require the user's confirmation before a certain action, like overwriting a file, is performed.

The action suggested by the computer can be approved by simply moving the input means in a, for instance computer generated, direction. Of course this can be extended to the requirement of following a more complex pattern of directions sequentially indicated to the user and eventually followed by exerting pressure on the touch pad at the final position or by pressing a button.

In another exemplary embodiment of the present invention, the indicated direction is aimed at a target position. This is beneficial in a large variety of scenarios. For instance, the target user interface surface position is located on a functional element, such as a key of a computer keyboard, or in a functional area, such as a functional area of a touch pad, touch screen or operator panel. When the element or area is contacted, it triggers execution of an operation of a device controlled by the user interface. In particular, determination of the target position may be based on the specific operation executed when the functional element or area is contacted.

A scenario such as a computer program requiring a users confirmation before a certain action is performed may again serve as an example. A common approach is to open a dialog menu containing a graphical button where a cursor has to be moved to, e.g. by moving a finger on a touch pad accordingly, so as to confirm the overwriting procedure. Taking advantage of the present invention, a similar confirmation user dialog becomes possible without having a visible cursor. The haptic signal can guide the user to the target position, i.e. a position located in an area covered by the graphical button. However, a visible signal can be given to the user to support the haptic signal, for instance by visualizing the direction to be indicated on a display.

A similar exemplary embodiment of the present invention can be realized for a device not having a display at all.

In an exemplary scenario such as a user working at a terminal which controls a conveying belt, the user may have to restart movement of the belt after it has been automatically stopped. With the invention as described above, it becomes possible to guide the user's finger to a certain position of an operating terminal. If the user follows the indicated direction, the conveying belt continues its movement.

Instead of an embodiment of the present invention in which the haptic signal serves for guiding the user to move the input means to a target position, it is of course also possible to user the haptic signal to indicate a direction that points away from a target position. In a computer game for example, the user, i.e. the player, often controls a virtual character by means of the user interface. The character has to be navigated through a maze. Certain walls limiting the maze may not be touched by the virtual character. Otherwise, the game ends. Taking advantage of the present invention, the direction of such wall can be indicated to the user by the haptic signal. He is thereby enabled to avoid contact if the virtual character and said wall.

In an exemplary embodiment of the present invention, the indicated direction is that from a starting point to a target position. This can be beneficial for many applications. For instance, this allows the use of a haptic signal that is only perceptible along a line connecting the starting position and the target position. This may contribute to reducing the power consumed for generating the haptic signal.

In another embodiment of the present invention, a priori knowledge is used for determining the location of the target position. If a user types a text with his fingers on a keyboard or with a stylus on a touch screen and enters the first letter of word, for example a consonant, it is highly probable that a vowel is to follow. With the help of a database it is then calculated which vowel is most likely to follow with respect to the first character. Consequently, the direction of the functional element or functional area linked to that character is indicated. An advantage of this embodiment is that it speeds up the data input significantly.

A further embodiment of the present invention uses a priori knowledge to support the user when handling objects in a drag-and-drop software environment displayed on, for example, a touch screen. Assuming the action most likely intended by the user in a specific scenario of use is that he wants to drag an already selected graphical object to a recycle bin symbol so that the object will be deleted, a haptic signal will indicate the direction of the target symbol to the user. He is thereby enabled to move the marked object to the desired position without having to locate the recycle bin symbol on the screen among a plurality of other symbols. Thereby, user experience is improved.

The signal indicating the target position to the user is a haptic signal. According to the present invention, this is advantageous because operation of the user interface involves contacting the user interface surface with an input means. Thus, the user either touches the interface directly with a body part or has indirect contact to it, for example with a stylus held in his hand. Furthermore, a haptic signal does not address to the visual or acoustic perception of the user. Therefore visual contact to the user interface is not necessary. Hence, the present invention allows visually or hearing impaired users to operate a user interface.

The only limitation regarding the nature of the haptic signal is that it has to be suitable for indicating a direction to a user.

A haptic sensation generation element serves for generating the haptic signal. For example, the user's fingers can be electrically stimulated by a grid of electrodes arranged at the user interface surface. When one of the electrodes is contacted by the user's finger, an electrical signal is given to the user, thereby indicating the direction to him.

In an exemplary embodiment of the present invention, the direction is indicated by vibrations perceptible by the user. These vibrations are generated by a rotating unbalanced mass. Different patterns of vibration are then used to encode the directional information. For example, a single short period of vibration indicates an upward direction within a surface plane of the user interface. Two short periods of vibration indicate a downward direction, a single longer period indicates a position to the left of the starting position while two longer vibration cycles indicate a position to the right. An advantage of the embodiment described above is that the input means do not have to be moved to enable the user to perceive the haptic signal and to conclude which direction is currently indicated.

A further exemplary embodiment of the present invention comprises establishing variable temperatures on the user interface surface. The temperature can then be varied in a specific manner in which the directional information is encoded. On the other hand, it is possible to use temperature gradients for encoding a direction. For instance, the surface can be heated up to a certain temperature that increases in the direction to be indicated. In this case, a haptic sensation element can be a heating element, e.g. a resistor that is passed through by an electrical current.

The variety of haptic signals suitable for indicating a direction also comprises the use of an air flow through the user interface surface to encode the directional information. For example, the air flow can be substantially orientated perpendicular to the user interface surface and its magnitude can increase or decrease in the direction to be indicated.

In another exemplary embodiment of the present invention the haptic sensation generation element is a piezoelectric actuator, a voice coil actuator, a servo motor a micro-electro-mechanical actuator or any other actuator. Piezoelectric actuators are small in size and react to small voltage variances with comparatively large compression or expansion.

An actuator or a plurality of actuators can be placed under the surface of the user interface, for example arranged in a grid under the visible surface of a touch screen or under the surface of a touch pad or under a key of keyboard. The actuator is then able to exert a force on the surface which is substantially perpendicular to it and which is perceptible by the user. A flexible touch screen or touch pad surface is able to pass the force to the input means. The same may hold for the surface of the keys. On the other hand, it is possible to provide movable keys that can project over the other keys of a keyboard when a force is exerted on them. The directional information can then be encoded in the movement of the keys.

An embodiment of the present invention comprises that the input means do not have to be moved to enable the user to perceive the haptic signal. For instance, this can be achieved by an actuator or a plurality of actuators exerting a force on the user interface surface that varies with time.

Another embodiment comprises an actuator indicating a direction by changing its state in a way similar to what has been described above with respect to the vibrations caused by a rotating unbalanced mass.

A flexible surface will react to a force exerted thereon by an actuator with deformation. In an embodiment of the present invention this deformation is reversible and creates a texture on the user interface surface that provides the direction information to the user.

In a grid of actuators a first actuator can assume a state in which it exerts a certain force on the user interface surface. Thereby, an elevation of a surface area of the interface is caused. In an exemplary embodiment of the present invention this state is passed from an actuator to another actuator arranged in the direction to be indicated, i.e. the latter actuator exerts the same force on the user interface surface that has been previously exerted by the former actuator. The force is exerted on a different position of the user interface surface. Thus, the surface elevation moves in said direction across the display.

Another exemplary embodiment of the present invention comprises that haptic sensation generation elements arranged on a circular area centered at the target position act the same way.

In case of the haptic sensation generation elements not being actuators but, for instance, heating elements, annular areas on the user interface surface can be generated. Each of the annular areas can then be characterized by a specific temperature.

An exemplary embodiment of the present invention comprises that the operation of a haptic sensation generation element depends on its distance to the target position.

In conjunction with the feature of an embodiment of the present invention that haptic sensation generation elements arranged on a circular area centered at the target position act the same way and the haptic sensation generation elements being heating elements, the temperature of annular areas with a specific temperature can increase or decrease from an outer annular area to an inner annular area. Following a negative or positive temperature gradient, the user will be directed to the target position or will be directed away from it.

In case of the haptic sensation generation elements being electrodes arranged at the user interface surface, electrodes in each of the annular areas can generate the same electrical signal, i.e. for example impress the same voltage on a user's body part such as a user's finger, to achieve a similar effect.

Another embodiment of the present invention comprises that actuators arranged on a circle centered at the target position exert the same force on the surface of the user interface simultaneously. In conjunction with the feature that the state of an actuator is passed on to another actuator arranged in the direction to be indicated, it is possible to create a wave-like surface structure moving along the user interface surface that comprises circular elevation areas contracting at the target position. A user will intuitively understand this type of haptic signal without having to move the input means.

In another embodiment of the present invention the force exerted by the actuators depends, or even linearly depends, on their respective distances to the target position. Thereby, the surface can be formed to a cone having its highest or lowest elevation at the target position. This haptic signal is intuitively understandable by the user.

Within the scope of the present invention lies the idea that the user interface surface texture forms a haptic symbol containing the information on the indicated direction. If the symbol is a static symbol, i.e. if it does not move along the user interface surface, the user has to move the input means over the surface to perceive the haptic signal.

An easily understandable haptic symbol is an arrow pointing in the direction to be indicated. This arrow can be formed when actuators lying in the area covered by the arrow exert a force on the display surface while actuators outside this area do not exert a force on the surface.

An alphabetic character or a numeral as a relief-like surface texture can, among many other possible textures, serve for the same purpose as long as it is suitable for indicating a direction to the user.

If the symbol moves across the user interface surface, the user may not have to move the input means in order to be able to perceive the haptic signal. To further simplify the understanding of the haptic signal, the symbol can move in the direction to be indicated. An arrow pointing from a starting position to a target position can move towards it and disappear when it eventually arrives at said target position. It can then reappear at the starting position and repeat said movement.

These and other aspects of the invention will be apparent from and elucidated with reference to the detailed description presented hereinafter. The features of the present invention and of its exemplary embodiments as presented above are understood to be disclosed also in all possible combinations with each other.

### BRIEF DESCRIPTION OF THE FIGURES

FIG. 1 is a flow chart exemplarily illustrating the control flow of an embodiment of a method according to the present invention;

FIG. 2 is a diagram schematically illustrating a first exemplary embodiment of an apparatus according to the present invention;

FIG. 3a is a schematic illustration of a second exemplary embodiment of an apparatus according to the present invention;

FIG. 3b is a sectional view of the apparatus of FIG. 3a;

FIG. 4a is a schematic illustration of a first haptic signal created by the second embodiment of an apparatus according to the present invention;

FIG. 4b is a schematic illustration of a second haptic signal created by the second embodiment of an apparatus according to the present invention;

FIG. 4c is a schematic illustration of a third haptic signal created by the second embodiment of an apparatus according to the present invention;

### DETAILED DESCRIPTION

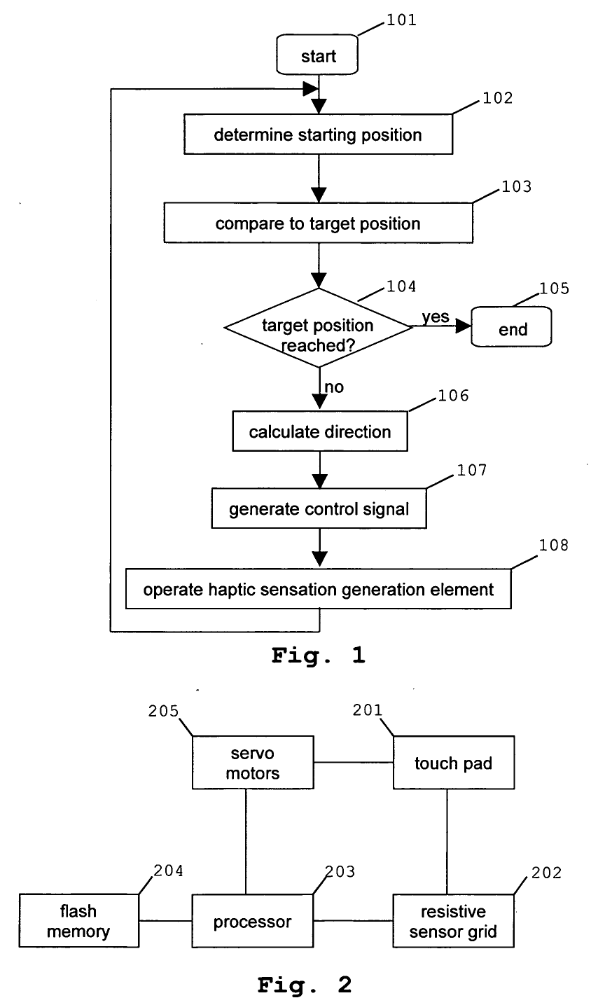

FIG. 1 is a flow chart exemplarily illustrating the control flow of an exemplary embodiment of the present invention.

Step 101 is the starting point. Step 102 comprises determining the starting position, i.e. the surface position where the input means (device), such as a stylus or a user's finger, currently contact the user interface surface.

The information on the starting position obtained in step 102 is then compared to the target position in step 103. The target position has, for example, been previously generated by a computer and is the position the user is most likely to aim for in the present situation of use. In the case, determining the target position is based on a priori knowledge.

Step 104 consists of checking whether the input means have reached the target position, i.e. whether the starting position and the target position are identical. If they are identical, the process terminates in step 105. If they are not identical, the direction from the starting position to the target position is calculated in step 106. The directional information is used in step 107 for generating a control signal. In step 108 a haptic sensation generation element, for example a piezoelectric actuator, performs the instructions conveyed by the control signal. Thereby, a haptic signal perceptible by a user is generated which indicates the calculated direction to the user. It is then returned to step 102 so that it is once again checked where the user has placed the input means and to adapt the haptic signal to the current starting position.

In another similar embodiment of a method according to the present invention, step 102 is not carried out. If, for instance, the direction to be indicated is perceptible independently of the current position of contact of the input means and the user interface surface, a starting position does not need to be determined.

The comparison of step 104 may then be performed without information on the current surface position as well. Instead, the user himself operates the user interface in a way suitable for indicating, that he has reached the position he has aimed for. This does not necessarily have to be the target position the haptic signal indicates to the user. For example, having reached his target user interface surface position, the user taps the user interface surface twice at said position, thereby, for instance, contacting the active area of a touch pad the target position is located in and at the same time notifying a system, for instance a computer operated by means of the user interface, of the arrival at his target position. As a reaction to this, the haptic signal can be changed to indicate another direction based on an operation that has been executed due to contacting said area.

On the other hand, in another embodiment of a method according to the present invention, the user interface can generate an additional haptic signal if the user reaches the indicated position by, for instance, generating a vibration signal or tapping the user interface surface by means of an actuator exerting a force thereon. In this case, the current position of contact of the input means and the user interface surface has to be detected.

In other cases, for example when a plurality of actuators are provided under the user interface surface, an actuator located directly at or located in the vicinity of the indicated position can constantly exert a pulsating force on the user interface surface. The user is then enabled to haptically perceive that the input means contacts the user interface at the target position or at least a surface position close to it without the detection of the current position of contact of the input means and the user interface surface. In another exemplary embodiment of a method according to the present invention, detecting the position of contact of the input means and the user interface surface is limited to an area surrounding the target position. It may then suffice to operate sensor elements, such as pressure sensors, that are configured to detect input means contacting the surface in said area. Other sensor elements can be shut off, thereby reducing power consumption of the user interface.

FIG. 2 is a diagram schematically illustrating a first exemplary embodiment of an apparatus according to the present invention.

In this embodiment the user interface is a touch pad 201. The rear side of the surface of the touch pad 201 is provided with a grid of resistive sensors. The sensors are connected to a processor 203. A flash memory 204 is connected to the processor 203. A plurality of servo motors 205 is provided at the rear side of the surface of the touch pad 201.

A user exerting pressure on the surface of the touch pad 201 makes a sensor forming part of the grid of resistive sensors 202 send a signal to the processor 203. Thereby, the processor 203 is notified of the position of contact of the user's finger and the surface of the touch pad 201. The processor 203 runs a program stored in the flash memory 204. The program further contains instructions enabling the processor 203 to calculate a target position which is in this case the position on the surface of the touch pad 201 the user is most likely to aim for in the present situation of use. In addition, instructions for calculating the direction of the target position based on the coordinates of the starting position are provided. The processor is configured to control the servo motors 205 in order to make them generate a haptic signal perceptible by the user. For this purpose, the servo motors 205 are coupled to the surface of the touch pad 201 so that they can exert a force on it resulting in deformation of the surface

The processor can further be configured to execute another program that the user controls via the user interface, i.e. the touch pad 201.

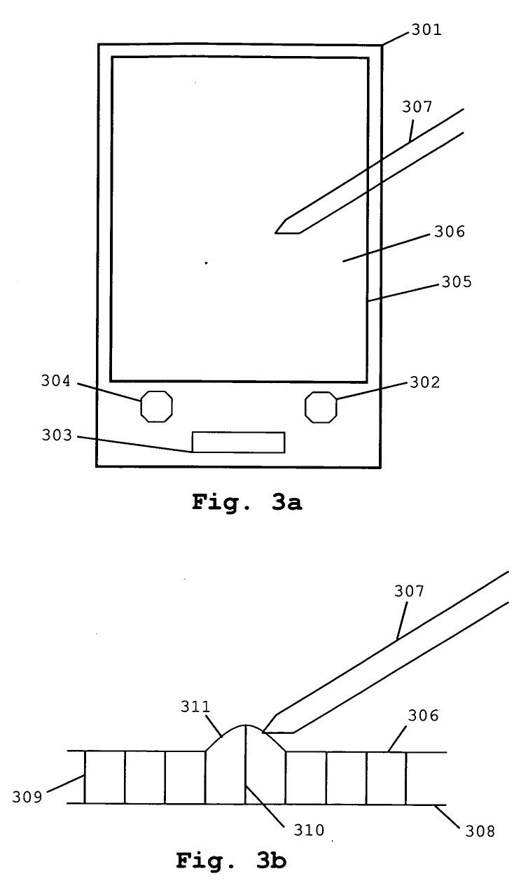

FIG. 3a is a schematic illustration of a second exemplary embodiment of an apparatus according to the present invention.

The apparatus of this embodiment forms part of a personal digital assistant 301. Keys 302, 303 and 304 are provided on the surface of the personal digital assistant 301. The personal digital assistant further comprises a touch screen 305, the surface 306 thereof being designed to be contacted with a stylus 307 or one of the user's fingers. The touch screen is sensitive to pressure.

FIG. 3b is a sectional view of the apparatus of FIG. 3a.

The surface 306 of the touch screen is supported by piezoelectric actuators 309 arranged in a grid. They are mounted on a plate 308. Due to an instruction that has been previously conveyed by a control signal, actuator 310 exerts a force on the touch screen surface 306, which is perpendicular to it. Thus, the surface 306 is deformed, and forms a bump 311.

When the stylus 307 is moved across the bump, the user will perceive the deformation of the touch screen surface 306. Varying forces applied to the touch screen surface 306 can be sensed by the user even without movement of the stylus 307.

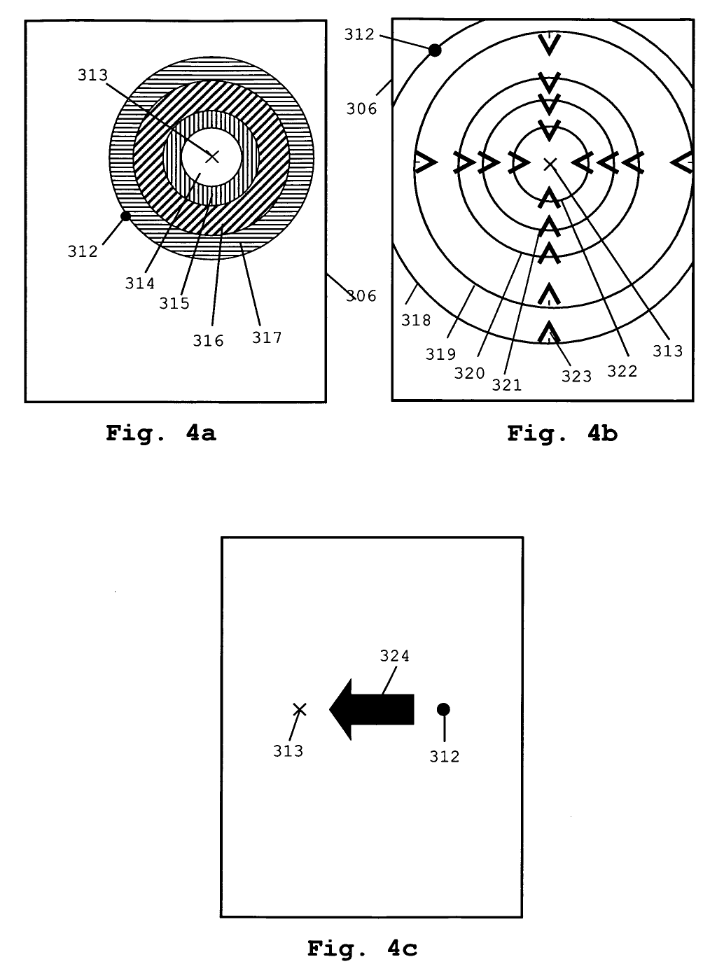

FIG. 4a is a schematic illustration of a first haptic signal created by the second embodiment of an apparatus according to the present invention.

The starting position 312 and the target position 313 are marked with a circle and a cross, respectively. Around the target position 313 annular areas 314, 315, 316 and 317 are highlighted. The piezoelectric actuators 309 (not visible) lying within such an annular area exert the same force on the touch screen surface 306 simultaneously. The force of the actuators 309 exerted on the touch screen is the strongest in area 317 and decrease from the outer annular area 317 to the inner annular area 314. When the user moves the stylus 307 (not visible) from the starting position 312 to the target position 313 via areas 314 to 317, the tip of the stylus descends from a position of high elevation 312 to a position of low elevation 313. Thus, the user perceives a haptic signal indicating the direction of the target position 313.

In case of the haptic sensation generation elements being heating elements, a similar surface structure can be generated. Each of the annular areas 314 to 317 can then be characterized by a specific temperature that increases or decreases from annular area 314 to annular area 317.

In case of the haptic sensation generation elements being electrodes arranged at the user interface surface, electrodes in each of the annular areas 314 to 317 can generate the same electrical signal, i.e. for example impress the same voltage on a user's body part, such as a user's finger.

FIG. 4b is a schematic illustration of a second haptic signal created by the second embodiment of an apparatus according to the present invention.

The exemplary haptic signal depicted in FIG. 4b shows a plurality of circles 318, 319, 320, 321 and 322 centered at the target position 313. The actuators 309 (not visible) arranged on such a circle exert the same force on the touch screen surface 306 simultaneously. Thus, the surface areas covered by one of the circles shown in FIG. 4b substantially exhibit the same surface elevation at the positions of the actuators covered by said circle, although the elevation may be lower at positions not directly coupled to an actuator (confer to the shape of bump 311 in FIG. 3b).

The circles having substantially the same surface elevation 318 to 322 are generated one after another. The actuators 309 elevating circular area 318 pass their states to the actuators coupled to circular area 319. At the same time the force exerted on circular area 318 is reduced so that the surface deformation disappears. Hence, the touch screen surface 306 is then only deformed in circular area 319, resulting in the same elevation that area 318 has had before. The same procedure is carried out for areas 320 to 322. Thereby, a wave-like surface texture is created by forming circles of elevated touch screen surface areas 318 to 322, wherein the circles move along the touch screen surface 306 and contract at the target position 313 as indicated by the arrows 323.

FIG. 4c is a schematic illustration of a third haptic signal created by the second embodiment of an apparatus according to the present invention.

In FIG. 4c the actuators 309 (not visible) form a haptic symbol on the touch screen surface. In this case, the haptic symbol is an arrow 324 pointing from the starting position 312 to the target position 313. When moving the input means across the contour of the arrow 324, the user perceives a haptic signal indicating the direction of the target position 313.

The functions illustrated by the processor 203 (see FIG. 2) executing the program stored in flash memory 204 can by viewed as means for providing a control signal, wherein the control signal is suitable for controlling a haptic sensation generation element to generate a haptic signal perceptible by a user contacting a user interface surface with input means and the haptic signal is suitable for indicating a predetermined direction on the user interface surface. Alternatively, the instructions of the program stored in flash memory 204 can be viewed as such means.

The invention has been described above by means of exemplary embodiments. It should be noted that there are alternative ways and variations which are obvious to a skilled person in the art and can be implemented without deviating from the scope and spirit of the appended claims.

Furthermore, it is readily clear for a skilled person that the logical blocks in the schematic block diagrams as well as the flowchart and algorithm steps presented in the above description may at least partially be implemented in electronic hardware and/or computer software, wherein it depends on the functionality of the logical block, flowchart step and algorithm step and on design constraints imposed on the respective devices to which degree a logical block, a flowchart step or algorithm step is implemented in hardware or software. The presented logical blocks, flowchart steps and algorithm steps may for instance be implemented in one or more digital signal processors, application specific integrated circuits, field programmable gate arrays or other programmable devices. The computer software may be stored in a variety of storage media of electric, magnetic, electromagnetic or optic type and may be read and executed by a processor, such as for instance a microprocessor. To this end, the processor and the storage medium may be coupled to interchange information, or the storage medium may be included in the processor.

What is claimed is:

1. A method comprising:
generating a haptic signal perceptible by a user contacting a user interface surface with an input device, the haptic signal being suitable for indicating a predetermined direction on the user interface surface.

2. The method of claim 1, wherein the direction aims at a target position or the direction aims away from a target position.

3. The method of claim 2, wherein the direction is the direction from a starting position to a target position.

4. The method of claim 3, wherein the starting position is the position of contact of the input device and the user interface surface.

5. The method of claim 1, wherein the user interface is a touch pad, a touch screen or a keyboard.

6. The method of claim 1, wherein the input device is a user's body part, in particular a user's finger, or a stylus.

7. The method of claim 2, wherein the target position is located in a functional area or on a functional element that triggers execution of an operation of a device controlled by the user interface when the area or element is contacted.

8. The method of claim 7, wherein determination of the target position is based on the specific operation that is executed when the functional element or area is contacted.

9. The method of claim 8, wherein the operation is a computer-executable instruction.

10. The method of claim 2, wherein determining the target position involves using a priori knowledge.

11. The method of claim 1, wherein generating the haptic signal comprises operating an actuator.

12. The method of claim 1, wherein the indicated direction is perceptible by the user without movement of the input device.

13. The method of claim 11, wherein the actuator or a plurality of actuators exerts a force on the user interface surface which is substantially perpendicular to the user interface surface.

14. The method of claim 13, wherein the state of an actuator which exerts a certain force on the user interface surface is passed on to an actuator arranged in the direction to be indicated.

15. The method of claim 2, wherein haptic sensation generation elements arranged on a circular area centered at the target position act the same way.

16. The method of claim 14, wherein actuators arranged on a circular area centered at the target position exert the same force on the surface of the user interface simultaneously.

17. The method of claim 15, wherein the operation of a haptic sensation generation element depends on its distance to the target position.

18. The method of claim 13, wherein the force exerted by the plurality of actuators forms a haptic symbol on the user interface surface.

19. The method of claim 18, wherein the haptic symbol is an arrow pointing towards the target position, an alphabetic character or a numeral.

20. The method of claim 18, wherein the symbol moves in the direction to be indicated.

21. An apparatus comprising:
a controller configured to provide a control signal, wherein the control signal is suitable for controlling a haptic sensation generation element to generate a haptic signal perceptible by a user contacting a user interface surface with an input device and the haptic signal is suitable for indicating a predetermined direction on the user interface surface.

22. The apparatus of claim 21, further comprising a detection unit configured to detect a position of contact of the input device and the user interface surface.

23. The apparatus of claim 21, further comprising a user interface.

24. The apparatus of claim 21, wherein the haptic sensation generation element is an unbalanced mass or a heating element.

25. The apparatus of claim 21, wherein the haptic sensation generation element is an actuator, in particular a piezoelectric actuator.

26. The apparatus of claim 25, wherein the actuator is configured to exert a force on the user interface surface which is substantially perpendicular to the user interface surface.

27. The apparatus of claim 26, wherein the user interface surface is flexible.

28. The apparatus of claim 21 forming part of a mobile phone, a personal digital assistant, a game console or a computer.

29. A computer-readable medium having a computer program stored thereon, the computer program comprising instructions operable to cause a processor to:
generate a control signal, wherein the control signal is suitable for controlling a haptic sensation generation element to provide a haptic signal perceptible by a user contacting a user interface surface with an input device and the haptic signal is suitable for indicating a predetermined direction on the user interface surface.

30. An apparatus comprising means for providing a control signal, wherein the control signal is suitable for controlling a haptic sensation generation element to generate a haptic signal perceptible by a user contacting a user interface surface with input means and the haptic signal is suitable for indicating a predetermined direction on the user interface surface.
